(19) United States
(12) Patent Application Publication
(10) Pub. No.: US 2008/0160619 A1
(43) Pub. Date: Jul. 3, 2008

(54) METHOD OF DETECTING OXYGEN LEAKAGE

(76) Inventors: Chun-Liang Tai, Hsin-Chu City (TW); Yi-Chang Yang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 12/045,708

(22) Filed: Mar. 11, 2008

Related U.S. Application Data
(63) Continuation-in-part of application No. 10/710,235, filed on Jun. 28, 2004.

(51) Int. Cl. G01N 31/22

(52) U.S. Cl. 436/3

(57) ABSTRACT

A method of detecting oxygen leakage. Firstly, a detection wafer with a first color positioned on the substrate is provided. Then, the detection wafer is loaded into a reaction tube from a loading chamber, and subsequently, the detection wafer is unloaded from the reaction tube. Finally, the detection wafer is observed to obtain a second color, wherein if oxygen leaks into the loading chamber, the second color is different from the first color.

### CROSS REFERENCE TO RELATED APPLICATIONS

This patent application is a continuation-in-part of and claims priority to U.S. patent application Ser. No. 10/710,235, filed on 2004 Jun. 28, and entitled “METHOD OF DETECTING OXYGEN LEAKAGE,” the entire contents of which are incorporated herein by reference.

### BACKGROUND OF THE INVENTION

1. Field of the Invention

The present invention relates to a method of detecting oxygen leakage, and more specifically, to a simple and fast method of detecting oxygen leakage for examining whether oxygen is leaking into a loading chamber of a vertical-type furnace.

2. Description of the Prior Art

Since a furnace is allowed to perform batch processes on a plurality of wafers simultaneously, it saves a lot of production costs to use the furnace in the semiconductor industry. Therefore, the furnace is applied in various semiconductor processes, such as a thermal oxidation, a chemical vapor deposition (CVD), or a thermal diffusion.

Please refer to FIG. 1. FIG. 1 is a schematic diagram of a vertical-type processing furnace. As shown in FIG. 1, a vertical-type processing furnace 10 includes a reaction tube 12, a loading chamber 11 positioned under the reaction tube 12, a movable shutter 13 positioned between the loading chamber 11 and the reaction tube 12, a wafer boat 14 positioned in the loading chamber 11 for carrying a plurality of wafers 16, and a boat elevator 18 for moving the wafer boat 14 along a direction indicated by an double arrow AA′. Additionally, the wafers 16 are firstly loaded into the wafer boat 14 in the loading chamber 11. Subsequently, the movable shutter 13 is opened and the wafer boat 14 is moved to the reaction tube 12 by the boat elevator 18. After the wafer boat 14 is totally positioned in the reaction tube 12, the movable shutter 13 is closed and a thermal reaction is performed on each of the wafers 16. As described above, the thermal reaction performed in the reaction tube 12 includes a thermal oxidation, a chemical vapor deposition, or a thermal diffusion. The thermal oxidation is usually performed in an oxygen-containing condition, while both of the chemical vapor deposition and the thermal diffusion should be performed in an oxygen-free condition.

Additionally, the thermal reactions performed in the reaction tube 12 are usually carried out at a quite high temperature. Therefore, when one of the thermal reactions requiring an oxygen-free environment is performed in the reaction tube 12, the reaction tube 12 and the loading chamber 11 should be kept oxygen-free, or else oxygen may penetrate into the wafer boat 16 and react with a surface layer of each wafer 16 to form an unnecessary oxide on each wafer 16. For example, please refer to FIG. 2. FIG. 2 is schematic diagram illustrating forming a silicon nitride layer 26 by use of the vertical-type processing furnace 10 shown in FIG. 1. As shown in FIG. 2, the wafer 16 includes a semiconductor substrate 20, at least a bit line 22 formed on the semiconductor substrate 20, and a tungsten layer 24 formed on the bit line 22. Then, the wafer 16 is loaded into the reaction tube 12 of the vertical-type processing furnace 10, and a chemical vapor deposition reaction is subsequently performed to form the silicon nitride layer 26 on the semiconductor substrate 20. However, if air leaks into the loading chamber 11 and the reaction tube 12 from an ambient environment, oxygen in the air would oxidize a surface of the tungsten layer 24 to form a tungsten oxide layer 28 on the tungsten layer 24, thereby increasing electrical resistance of the tungsten layer 24.

The vertical-type processing furnace 10 usually includes an air suction device, such as a suction motor, for pumping air out of the reaction tube 12. Removing air from the reaction tube 12 by use of the air suction device is so efficient that oxygen can be prevented from leaking into the reaction tube 12. In addition, methods used for reducing an oxygen concentration in the loading chamber 11 include using a fan for pumping air out of the loading chamber 11 or continuously blowing a nitrogen gas into the loading chamber 11. However, either using the fan or continuously blowing the nitrogen gas is too inefficient to reduce the oxygen concentration effectively. Accordingly, if the air leaks into the loading chamber 11 because screws become loose or valves are not closed tightly, the air cannot be effectively and immediately expelled from the loading chamber 12, so when the movable shutter 13 is opened, the high temperature in the reaction tube 12 would drive oxygen to induce an oxidation reaction to form an unnecessary by-product on each wafer 16. Additionally, the loading chamber 12 usually includes an oxygen detector (not shown) therein for monitoring the oxygen concentration in the loading chamber 11. Nevertheless, when the oxygen detector is broken, process engineers usually cannot notice that situation immediately because the oxygen detector is only maintained once a year. Therefore, if the oxygen detector is broken, it cannot be sensed at once that the air has leaked into the loading chamber 11. As a result, it is an important issue to look for a simple method of detecting oxygen leakage so that process engineers can easily examine whether oxygen leaks into the loading chamber 11 or not.

### SUMMARY OF THE INVENTION

It is therefore a primary objective of the claimed invention to provide a method of detecting oxygen leakage in order to examine whether oxygen leaks into a loading chamber for solving the above-mentioned problem.

According to the claimed invention, a method of detecting oxygen leakage is provided. Firstly, a detection wafer having a substrate and a metallic film on the substrate is provided. Afterwards, the surface of the detection wafer is observed to obtain a first color. Then, the detection wafer is loaded into a reaction tube from a loading chamber, and subsequently, the detection wafer is unloaded from the reaction tube. Finally, the surface of the detection wafer is observed to obtain a second color, wherein if oxygen leaks into the loading chamber, a metal oxide film is formed by oxidizing the metallic film, and the second color is different from the first color.

It is an advantage over the prior art that the claimed invention can judge whether oxygen leaks into the loading chamber through observing a color variation of the detection wafer, thereby obtaining detection results easily and quickly. Additionally, since a process for manufacturing the detection wafer is easy and simple, the claimed invention provides a method of detecting oxygen leakage with a lot of economic benefits.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a vertical-type processing furnace.

FIG. 2 is schematic diagram illustrating forming a silicon nitride layer by use of the vertical-type processing furnace shown in FIG. 1.

FIG. 3 is a schematic diagram of a detection wafer according to the preferred embodiment of the present invention.

FIG. 4 and FIG. 5 are schematic diagrams illustrating an operation of a vertical-type processing furnace according to the preferred embodiment of the present invention.

FIG. 6 is a flow chart illustrating a method of detecting oxygen leakage according to the preferred embodiment of the present invention.

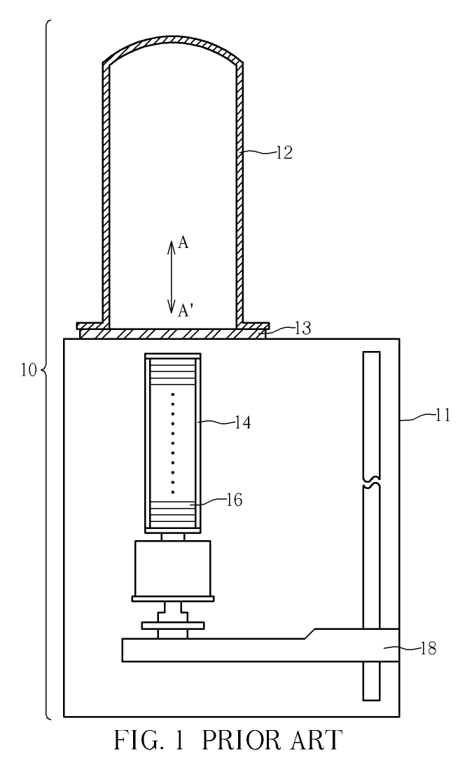

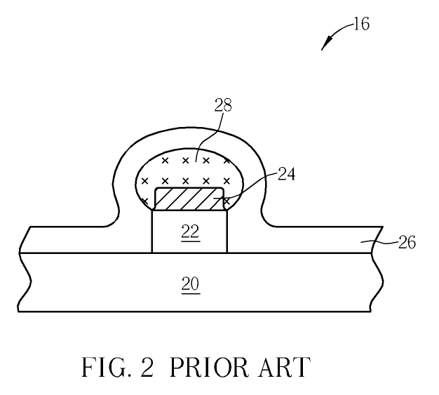

### DETAILED DESCRIPTION

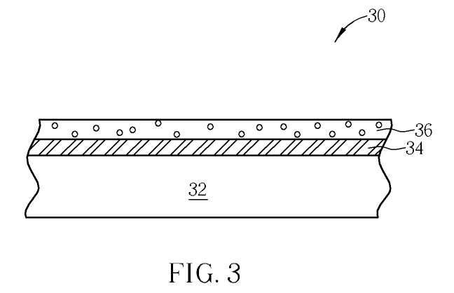

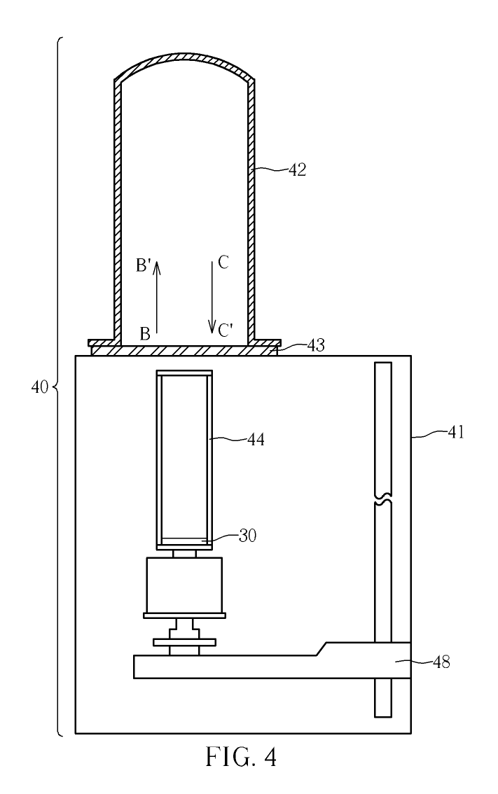

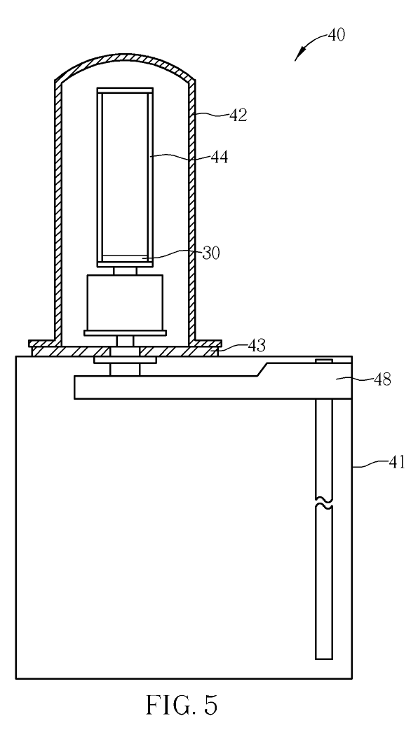

Since the present invention provides a method of detecting oxygen leakage and utilizes a detection wafer to examine if air leaks into a loading chamber of a vertical-type processing furnace, the detection wafer and corresponding apparatus are described firstly before the method of detecting oxygen leakage is explained. Please refer to FIG. 3 to FIG. 5. FIG. 3 is a schematic diagram of a detection wafer according to the preferred embodiment of the present invention. FIG. 4 and FIG. 5 are schematic diagrams illustrating an operation of a vertical-type processing furnace according to the preferred embodiment of the present invention. As shown in FIG. 3, a detection wafer 30 includes a substrate 32, a detection film 36 formed on the substrate 32, and an optional buffer film 34 formed between the substrate 32 and the detection film 36 for improving adhesion between the substrate 32 and the detection film 36. In the preferred embodiment of the present invention, the substrate 32 is a silicon substrate, and the buffer film 34 is composed of a titanium nitride (TiN), which usually has a gold color. Additionally, the detection film 36 is a tungsten (W) film and a thickness of the tungsten film is between 4000 Å and 8000 Å, preferably 6000 Å. The color of the tungsten film is steel-gray or tin-white, however, the detection wafer 30 as viewed by an observer takes on the appearance may be of gold because of the presence of the optional buffer film 34.

As shown in FIG. 4 to FIG. 5, a vertical-type processing furnace 40 includes a reaction tube 42, a loading chamber 41 positioned under the reaction tube 42, a movable shutter 43 positioned between the loading chamber 41 and the reaction tube 42, a wafer boat 44 positioned in the loading chamber 41, and a wafer elevator 48 for moving the wafer boat 44. As shown in FIG. 4, the detection wafer 30 is firstly sent into the loading chamber 41 of the vertical-type processing furnace 40 and is loaded into the wafer boat 44, while a nitrogen gas is continuously blown into the loading chamber 41. Additionally, a flow rate of the nitrogen gas used in the loading chamber 41 is between 100 L/min and 200 L/min, preferably 150 L/min. Thereafter, the movable shutter 43 is opened and the wafer elevator 48 is driven to move the wafer boat 44 into the reaction tube 42 along a direction indicated by an arrow BB′, as shown in FIG. 4 and FIG. 5. It should be noted that no thermal reaction is performed in the reaction tube 42 when the detection wafer 30 stays in the reaction tube 42, and a temperature of the reaction tube 42 is between 600° C. and 800° C., preferably 700° C., which is substantially the same as a temperature required by a thermal reaction that is predetermined to be performed in the reaction tube 42.

Subsequently, as shown in FIG. 4, the wafer elevator 48 starts to move the wafer boat 44 along a direction indicated by an arrow CC′, and the wafer boat 44 is moved to the loading chamber 41 from the reaction tube 42. Then, the detection wafer 44 is unloaded from the vertical-type processing furnace 40. After that, the detection wafer 30 is observed and a color of the detection wafer 30 is obtained. Furthermore, if the color of the detection wafer 30 as viewed by an observer taken on the appearance is, for example, green or blue, the loading chamber 41 is contaminated by oxygen and the vertical-type processing furnace 40 should be examined to determine whether screws have become loose or if there are valves that are not closed tightly. In other words, the detection film 36 is oxidized in the reaction tube 42 and a tungsten oxide layer is formed on the detection wafer 30, so the color of the detection wafer 30 as viewed by an observer changes from gold to green or blue.

As mentioned above, the temperature of the reaction tube 42 is between 600° C. and 800° C. Therefore, if air leaks into the loading chamber 41 from an ambient environment, oxygen in the air would oxidize the tungsten film 36 of the detection wafer 30 to form a tungsten oxide layer on the detection wafer 30 when the movable shutter 43 is opened. Furthermore, the color of the original detection wafer 30 as viewed by an observer taken on the appearance may gold, and a color of an oxidized detection wafer 30 is varied with an oxidation level of tungsten, such as green or blue. Therefore, when the detection wafer 30 is unloaded from the vertical-type processing furnace 40 and has a new color different from the original one, it means that the loading chamber 41 is contaminated by oxygen. Accordingly, the present invention can judge whether oxygen leaks into the loading chamber 41 through observing a color variation of the detection wafer 30.

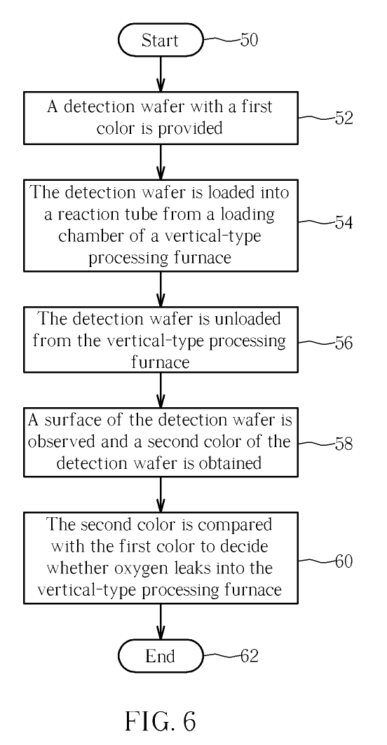

Please refer to FIG. 6. FIG. 6 is a flow chart illustrating a method of detecting oxygen leakage according to the preferred embodiment of the present invention. As shown in FIG. 6, the method of detecting oxygen leakage includes the following steps:

Step 50: Start.

Step 52: A detection wafer 30 with a first color is provided.

Step 54: The detection wafer 30 is loaded into the reaction tube 42 from the loading chamber 41 of the vertical-type processing furnace 40.

Step 56: The detection wafer 30 is unloaded from the vertical-type processing furnace 40.

Step 58: A surface of the detection wafer 30 is observed and a second color of the detection wafer 30 is obtained.

Step 60: The second color is compared with the first color to decide whether the second color is the same as the first color or not. When the second color is the same as the first color, oxygen does not leak into the loading chamber 41 of the vertical-type processing furnace 40. Otherwise, oxygen leaks into the loading chamber 41 of the vertical-type processing furnace 40.

Step 62: End.

In brief, the present invention provides a detection wafer 30, and then, the detection wafer 30 is loaded into the vertical-type processing furnace 40. Thereafter, the detection wafer 30 is unloaded from the vertical-type processing furnace 40. Finally, it can be judged whether oxygen leaks into the loading chamber 41 through observing a color variation of the detection wafer 30.

It should be noted that the present invention could be applied in any kind of reaction chambers where reactions requiring high temperature and oxygen-free conditions would be performed. As described above, the detection film 36 may be a tungsten film, but the detection film 36 also can be any material that is sensitive to oxygen and has a distinguishable color from its oxide.

In comparison with the prior art, the present invention utilizes the detection wafer 30 for examining if oxygen leaks into the loading chamber 41 of the vertical-type processing furnace 40. Additionally, the present invention can judge whether oxygen leaks into the loading chamber 41 through observing a physical variation, i.e. color variation, so that detection results can be easily and quickly obtained according to the present invention. Furthermore, since a process for manufacturing the detection wafer 30 is easy and simple, the present invention provides a method of detecting oxygen leakage with a lot of economic benefits.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of detecting oxygen leakage comprising:
providing a detection wafer having a substrate and a metallic film on the substrate;
observing the detection wafer to obtain a first color;
loading the detection wafer into a reaction tube from a loading chamber, and
subsequently, unloading the detection wafer from the reaction tube; and
observing the detection wafer to obtain a second color, wherein if oxygen leaks into the loading chamber, a metal oxide film is formed by oxidizing the metallic film, and the second color is different from the first color.

2. The method of claim 1 wherein the metallic film comprises a tungsten film and the first color is gold.

3. The method of claim 2 wherein the substrate comprises a silicon substrate and the detection wafer further comprises a titanium nitride layer positioned between the tungsten film and the silicon substrate.

4. The method of claim 1 wherein the loading chamber and the reaction tube are installed in a vertical-type processing furnace, and the vertical-type processing furnace further comprises a wafer boat positioned in the loading chamber for carrying a plurality of semiconductor wafers and a boat elevator for moving the wafer boat between the loading chamber and the reaction tube.

5. The method of claim 4 further comprising continuously blowing a nitrogen gas into the loading chamber, wherein a flow rate of the nitrogen gas is between 100 L/min and 200 L/min.

6. The method of claim 5 wherein a temperature of the reaction tube is between 600° C. and 800° C.
